(19) United States
(12) Patent Application Publication
(10) Pub. No.: US 2023/0327121 A1
(43) Pub. Date: Oct. 12, 2023

(54) BINDER, POSITIVE ELECTRODE PLATE AND BATTERY

(71) Applicant: ZHUHAI COSMX BATTERY CO., LTD., Zhuhai (CN)

(72) Inventors: Panlong GUO, Zhuhai (CN); Lin CHU, Zhuhai (CN); Weiping CHEN, Zhuhai (CN); Suli LI, Zhuhai (CN)

(73) Assignee: ZHUHAI COSMX BATTERY CO., LTD., Zhuhai (CN)

(21) Appl. No.: 18/297,219

(22) Filed: Apr. 7, 2023

(30) Foreign Application Priority Data
Apr. 12, 2022 (CN) 202210383937.6

(51) Int. Cl. H01M 4/62; H01M 4/04; H01M 10/0525

(52) U.S. Cl. CPC H01M 4/622; H01M 4/0404; H01M 10/0525; H01M 2004/028

(57) ABSTRACT

Disclosed are a binder and a battery including the binder. The novel aqueous binder with self cross-linking performance, strong bonding performance, and good flexibility is obtained by copolymerizing a plurality of functional monomers. The binder has the characteristics of good processability and high solid content of the slurry when applied to a positive electrode; the positive electrode plate obtained by applying the slurry has high peeling force and good cyclic stability, and its rate capability is superior to that obtained by applying PVDF binder; and the binder is green and environmental friendly, and it is expected to replace PVDF in batteries and achieve large-scale application.

### CROSS-REFERENCE TO RELATED APPLICATIONS

The present application claims priority to Chinese Patent Application No. 202210383937.6, filed on Apr. 12, 2022, which is hereby incorporated by reference in its entirety.

### TECHNICAL FIELD

The present disclosure relates to the field of battery technologies, and to a binder and a battery including the binder.

### BACKGROUND

The lithium ion batteries have been widely used in various fields, such as electric vehicles, consumer electronic devices and energy storage power stations, after 30 years of rapid development, since the commercialization of the lithium ion batteries in the 1990s, and the lithium ion batteries also have an exponential growth in consumption. Production and manufacturing of the lithium ion batteries are also increasingly pursuing greenness, environmental protection, health and economy.

Compared with using water as the solvent in the negative electrode slurry, the positive electrode plate of traditional lithium batteries is prepared by using N-methylpyrrolidone (NMP) as the solvent and polyvinylidene fluoride (PVDF) as the binder. However, the price of the polyvinylidene fluoride is almost five times that of sodium carboxymethylcellulose (CMC-Na) which does not include fluorine. In addition, materials need to be recovered and recycled by expensive processes during the electrode drying process, due to the toxicity of NMP. Therefore, the preparation of the batteries not only need to consider the cost of raw materials, but also need to consider additional processing costs, which make the NMP/PVDF system very expensive in general.

At present, there are many researches on the aqueous positive electrode binder, but most of the aqueous positive electrode binder are composite systems including a plurality of polymers, and it is not conducive to the stability of the slurry, due to the physical interaction between the different polymers in such composite systems. In addition, the positive electrode binder commonly used, such as the 136DL of INDIGO, has higher glass transition temperature, resulting that the positive electrode plates are hard and brittle, and easy to crack during the applying and drying processes.

### SUMMARY

In view of the shortcomings in the present aqueous positive electrode binder, the present disclosure provides a binder and a battery comprising the binder. The binder is an aqueous positive electrode binder, which is obtained by copolymerizing a plurality of functional monomers. The binder has the characteristics of good dispersibility, good self cross-linking, strong bonding performance and good flexibility. When the binder is applied to the positive electrode, the positive electrode has the characteristics of good processability and stable viscosity of the solid content in slurry. Meanwhile, the positive electrode plate obtained by applying the slurry has high peeling force and good cyclic stability, and the rate capability is superior to that of the PVDF binder. Moreover, the binder is green and environmental friendly, and it is expected to replace the PVDF in the batteries and achieve large-scale application.

In order to achieve the object, the specific technical solutions are as follows:

A binder is provided, where the binder includes at least one polymer, and the polymer includes at least one repeating unit shown in Formula 1, at least one repeating unit shown in Formula 2, and at least one repeating unit shown in Formula 3:

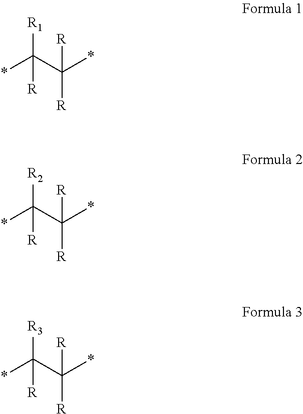

where R₁ is a dispersion group, R₂ is a flexible group, and R₃ is a self cross-linkable group; R is the same or different, and is independently selected from C₁₋₆ alkyl or hydrogen; * is a connecting end.

According to an embodiment of the present disclosure, Rs are the same or different, and are independently selected from C₁₋₃ alkyl or hydrogen.

According to an embodiment of the present disclosure, Rs are the same or different, and are independently selected from CH₃ or hydrogen.

According to an embodiment of the present disclosure, the dispersion group refers to a group with dispersion performance, and is specifically a group with dispersion performance in the water system. The introduction of the dispersion group may make the binder have good aqueous dispersion characteristics, so that the binder fully wets an active material, which realize the effect of infiltrating the surface of the active material. In addition, the introduction of the dispersion group may also make a slurry containing the positive active material stable in water without settlement, so as to ensure the stability of the applying process and bonding.

According to an embodiment of the present disclosure, the dispersion group, that is R1, is selected from pyrrolidone group

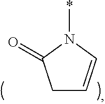

imidazolyl

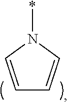

pyridyl

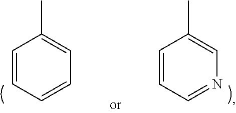

CONHR′, (R′ is H or C₁₋₆ alkyl), —CN, —COOH, —COOLi, or —COONa.

R₁ is derived from a polymerizable monomer with dispersion performance, preferably, is derived from the polymerizable monomer including a carbon-carbon double bond and having dispersion performance, and the polymerizable monomer is capable of forming the repeating unit shown in Formula 1; and the polymerizable monomer shown in Formula 1 is selected from at least one of: 1-vinyl-2-pyrrolidone, 1-vinylimidazole, vinylpyridine, methacrylamide, methacrylonitrile, methacrylic acid, lithium methacrylate, sodium methacrylate, acrylamide, vinyl cyanide, propenoic acid, lithium acrylate, and sodium acrylate.

According to an embodiment of the present disclosure, the flexible group refers to a group with flexibility, and a glass transition temperature Tg of a homopolymer obtained by the polymerizable monomer containing the flexible group is less than or equal to 25° C. The introduction of the flexible group may make the binder have good flexibility, so that the elongation at break is significantly improved, and the toughness is improved, thereby achieving the effect of improving the flexibility of a electrode plate.

According to an embodiment of the present disclosure, the flexible group, that is R₂, is selected from —COOR₄, —COO—(CH₂CH₂O)ₙ—CH₃, or —COO—R₅—OH; where R₄ is C₁₋₆ alkyl, R₅ is C₁₋₆ alkylene, and n is an integer selected from 1 to 15.

R₂ is derived from a flexible polymerizable monomer, preferably, is derived from the flexible polymerizable monomer including a carbon-carbon double bond, and the polymerizable monomer is capable of forming the repeating unit shown in Formula 2; and the polymerizable monomer is selected from at least one of: methyl acrylate, ethyl acrylate, propyl acrylate, butyl acrylate, pentyl acrylate, hydroxyethyl acrylate, and poly(ethylene glycol) methyl ether methacrylate.

According to an embodiment of the present disclosure, the self cross-linkable group refers to a group with self cross-linking performance under a certain condition, and specifically a group that may realize cross-linking by external heating without introducing a catalyst and only requiring a anhydrous condition. The introduction of the self cross-linkable group may make the binder have good self cross-linking performance, so that a cross-linked network is formed, and realize the effect of improving the stability and the peeling force of the electrode plate.

According to an embodiment of the present disclosure, the self cross-linkable group, that is R₃, is selected from —C(OH)═N—R₆—OH,

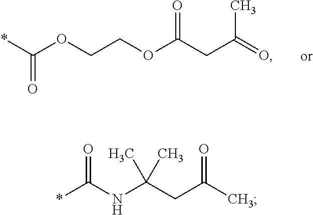 [SMILES: *C(=O)OCCOC(=O)CC(C)=O ; *C(=O)NC(C)(C)CC(C)=O]

and R₆ is C₁₋₆ alkylene.

R₃ is derived from a polymerizable monomer with self cross-linking performance, preferably, is derived from the polymerizable monomer including a carbon-carbon double bond and having self cross-linking performance, and the polymerizable monomer is capable of form the repeating unit shown in Formula 3; and the polymerizable monomer is selected from at least one of: acetoacetoxyethyl methacrylate, N-hydroxymethyl acrylamide, N-hydroxyethyl acrylamide and diacetone acrylamide.

According to an embodiment of the present disclosure, the polymer is a copolymer polymerized by at least one repeating unit shown in Formula 1, at least one repeating unit shown in Formula 2, and at least one repeating unit shown in Formula 3. Specifically, the polymer is a random copolymer or a block copolymer, preferably, is a random copolymer.

According to an embodiment of the present disclosure, the repeating unit shown in Formula 1 accounts for 40 mol % to 80 mol % of the total mole of the copolymer (For example, 40 mol %, 50 mol %, 60 mol %, 70 mol %, 80 mol %). The repeating unit shown in Formula 2 accounts for 20 mol % to 50 mol % of the total mole of the copolymer (For example, 20 mol %, 30 mol %, 40 mol %, 50 mol %). The repeating unit shown in Formula 3 accounts for 0.1 mol % to 10 mol % of the total mole of the copolymer (For example, 0.1 mol %, 1 mol %, 5 mol %, 8 mol %, 10 mol %). By regulating the molar ratio of the repeating unit shown in Formula 1, the repeating unit shown in Formula 2 and the repeating unit shown in Formula 3, the performance of the binder may be adjusted.

According to an embodiment of the present disclosure, the weight-average molecular weight of the polymer ranges from 3000 Da to 2 million Da (For example, 3000 Da, 5000 Da, 10,000 Da, 50,000 Da, 100,000 Da, 500,000 Da, 1 million Da, 2 million Da). The polymer with the weight-average molecular weight in this range may satisfy the controllable adjustment of the bonding force. When the weight-average molecular weight of the polymer is too low, the cohesion between molecules is reduced, and the bonding force is too low. When the weight-average molecular weight of the polymer is too high, for example, higher than 2 million, the molecules are seriously wound in a using process, which is not conducive to the bonding of active materials.

According to an embodiment of the present disclosure, a decomposition temperature of the polymer is greater than 300° C. That is, the polymer will not decompose at a temperature below 300° C., which indicates that the polymer has a high thermal stability. The glass transition temperature of the polymer is less than 60° C. (DSC test), that is, the polymer has a high bonding strength, and may enable the binder to have good toughness, so that the electrode plate may maintain a certain toughness.

According to an embodiment of the present disclosure, a maximum stress of the polymer ranges from 0.1 MPa to 1000 MPa (For example, 0.1 MPa, 1 MPa, 10 MPa, 50 MPa, 100 MPa, 500 MPa, 800 MPa, 1000 MPa).

According to an embodiment of the present disclosure, the elongation at break of the polymer ranges from 5% to 600% (For example, 5%, 50%, 100%, 200%, 400%, 600%).

According to an embodiment of the present disclosure, the binder further includes a solvent component, and the solvent component is selected from water, such as deionized water. When the water is selected as the solvent component, the binder system has the characteristics of no solvent releasing, environmental friendly, non-combustion, low production costs, safe application and the like.

According to an embodiment of the present disclosure, an addition amount of the solvent component is not particularly defined, as long as the binder having a specific solid content, viscosity and pH value can be prepared.

According to an embodiment of the present disclosure, the solid content of the binder ranges from 0.1 wt % to 10 wt % (For example, 0.1 wt %, 0.3 wt %, 0.5 wt %, 1 wt %, 2 wt %, 3 wt %, 4 wt %, 5 wt %, 8 wt %, 10 wt %), preferably, ranges from 0.3 wt % to 5 wt %.

According to an embodiment of the present disclosure, the viscosity of the binder ranges from 100 mPa s to 30000 mPa s (For example, 100 mPa s, 500 mPa s, 1000 mPa s, 5000 mPa s, 10000 mPa s, 20000 mPa s, 30000 mPa s), preferably, ranges from 3000 mPa s to 15000 mPa s.

According to an embodiment of the present disclosure, the pH value of the binder ranges form 5 to 7.

A research find that selecting a binder with the above-mentioned solid content, viscosity and pH value may achieve better bonding performance. For example, the binder may be suitable for different active materials, and also helpful in thickening and dispersin g the slurry.

According to an embodiment of the present disclosure, the polymer of the binder have a structural formula as shown in the following formula I:

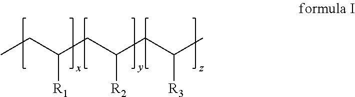

where, x:y:z is (40 mol %-80 mol %):(20 mol %-50 mol %):(0.1 mol %-10 mol %); and the definition of R₁, R₂, and R₃ are the same as above.

According to an embodiment of the present disclosure, the polymer of the binder have a structural formula as shown in the following formula II:

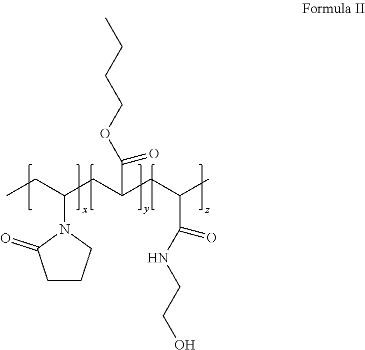

where, the definitions of x, y, and z are the same as above.

The polymer as shown in Formula II is obtained by copolymerizing 1-vinyl-2-pyrrolidone, butyl acrylate and N-hydroxyethyl acrylamide, where 1-vinyl-2-pyrrolidone plays a role in dispersing, butyl acrylate plays a role in improving flexibility, and N-hydroxyethyl acrylamide that is cross-linked in a dehydration process plays a role in cross-linking, so that the cross-linking network is formed, and the effect of improving the stability of the electrode plate is realized.

According to an embodiment of the present disclosure, the binder is cross-linked in the dehydration process (drying process) to form the cross-linking network, so that the stability of the electrode plate is improved.

The present disclosure further provides a method for preparing the binder, and the method includes the following steps:

Dissolving the polymerizable monomer containing R₁ group, the polymerizable monomer containing R₂ group and the polymerizable monomer containing R₃ group in water, selecting a suitable initiator and a suitable catalyst depending on the polymer system, and performing a copolymerization reaction to obtain the binder.

According to an embodiment of the present disclosure, the copolymerization method may selected from radical polymerization, oxidation-reduction system polymerization, reversible addition-fragmentation chain-transfer polymerization (RAFT), atom transfer radical polymerization (ATRP) or oxidation-reduction system polymerization and the like.

According to an embodiment of the present disclosure, the reaction is performed under the protection of inert gas, and the inert gas is high-purity nitrogen or argon.

According to an embodiment of the present disclosure, a temperature of the copolymerization reaction ranges from 30° C. to 100° C. (For example, 30° C., 40° C., 50° C., 60° C., 70° C., 80° C., 100° C.), preferably from 40° C. to 80° C.

According to an embodiment of the present disclosure, the copolymerization reaction is performed under a stirring, and the stirring speed ranges from 300 rpm to 1000 rpm, preferably from 500 rpm to 800 rpm.

According to an embodiment of the present disclosure, the initiator is selected from at least one of: potassium persulfate, ammonium persulfate, sodium persulfate, potassium permanganate, a mixture of sodium persulfate and sodium bisulfite, a mixture of ferrous sulfate and hydrogen peroxide, a mixture of ammonium persulfate and tetramethylethylenediamine, and a mixture of ammonium persulfate and sodium sulfite. The addition amount of the initiator ranges from 0.1 wt % to 2 wt % (For example, 0.1 wt %, 0.5 wt %, 1 wt %, 1.5 wt %, 2 wt %) of the total mass of a comonomer.

The present disclosure further provides an application of the binder in batteries.

According to an embodiment of the present disclosure, the binder is used as a binder in the positive electrode of the batteries.

The present disclosure provides a positive electrode plate, where the positive electrode plate includes the binder mentioned above.

According to an embodiment of the present disclosure, the positive electrode plate includes a positive current collector and a positive active material layer applied to at least one side surface of the positive current collector, and the positive active material layer includes the binder mentioned above.

According to an embodiment of the present disclosure, the addition amount of the binder accounts for 0.2 wt % to 25 wt % (For example, 0.2 wt %, 1 wt %, 5 wt %, 10 wt %, 15 wt %, 20 wt %, 25 wt %) of the total mass of the positive active material layer, for example, 0.5 wt % to 15 wt %, and for example, 1 wt % to 5 wt %.

According to an embodiment of the present disclosure, the positive active material layer further includes a positive active material and a conductive agent.

According to an embodiment of the present disclosure, the positive current collector is a single-sided smooth aluminum foil, a double-sided smooth aluminum foil or a porous aluminum foil.

According to an embodiment of the present disclosure, the positive active material is at least one of: lithium iron phosphate, ternary positive electrode material (such as NCM622, NCM811, and NCA), lithium cobaltate, and lithium manganate.

According to an embodiment of the present disclosure, the conductive agent is at least one of: graphite, carbon black, acetylene black, graphene, and carbon nanotubes.

According to an embodiment of the present disclosure, an average peeling strength of the positive electrode plate including the binder ranges from 0.1 N/m to 30 N/m (For example, 0.1 N/m, 1 N/m, 5 N/m, 10 N/m, 15 N/m, 20 N/m, 25 N/m, 30 N/m).

The present disclosure further provides a method for preparing the positive electrode plate, including the following steps:
applying a slurry including the binder to the surface of one or two side of the positive current collector to obtain the positive electrode plate.

According to an embodiment of the present disclosure, the method for preparing the positive electrode plate includes the following steps:
(1) mixing the positive active material, the conductive agent, and the binder to obtain a positive electrode slurry;
(2) applying the positive electrode slurry to the surface of the positive current collector, followed by baking to obtain the positive electrode plate.

The present disclosure further provides an application of the positive electrode plate in the batteries.

The present disclosure provides a battery, where the battery includes the binder mentioned above.

According to an embodiment of the present disclosure, the battery includes the positive electrode plate mentioned above.

According to an embodiment of the present disclosure, the battery is obtained by assembling a positive electrode plate, a separator, a negative electrode plate and electrolyte. For example, assembling the positive electrode plate, the negative electrode plate and the separator by means of common winding manner or laminating manner in the art to obtain a cell, packaging by an aluminum-plastic film, baking, injecting the electrolyte, chemical formatting, and secondary sealing sequentially to obtain a lithium ion battery.

According to an embodiment of the present disclosure, a negative active material in the negative electrode plate includes at least one of: monatomic silicon, silicon monoxide, natural graphite, artificial graphite, mesophase carbon fiber, mesocarbon microbeads, soft carbon, and hard carbon.

The beneficial effects of the present disclosure are as follows:

A novel aqueous binder with self cross-linking performance, strong bonding performance, and good flexibility is obtained by copolymerizing a plurality of functional monomers. When the binder is applied to a positive electrode, the positive electrode has the characteristics of good processability and high solid content of the slurry; the positive electrode plate obtained by applying the slurry has high peeling force and good cyclic stability; the rate capability is superior to that of the PVDF binder; the binder is green and environmental friendly; and it is expected to replace the PVDF in the batteries and achieve large-scale application.

### BRIEF DESCRIPTION OF THE DRAWINGS

FIG. 1 is electrochemical impedance spectrogram of the batteries of Comparative Example 1 and Examples 1 to 3.

### DETAILED DESCRIPTIONS OF THE EMBODIMENTS

The present disclosure will be further described in detail with reference to specific embodiments hereinafter. It should be understood that the following embodiments are only illustratively explicating and explaining the present disclosure, and should not be interpreted as limiting the protection scope of the present disclosure. All technologies implemented based on the foregoing contents of the present disclosure fall with the scope intended to protect by the present disclosure.

The experiment methods used in the following examples are conventional methods unless otherwise specified; and the reagents, materials, or the like, used in the following examples may be all obtained from commercial sources unless otherwise specified.

### Preparation Example 1

Synthesis of Binder 1: dissolving 1-vinyl-2-pyrrolidone (6.66 g, 60 mmol), butyl acrylate (3.84 g, 30 mmol), N-hydroxyethyl acrylamide (1.15 g, 10 mmol), ammonium persulfate (0.1 g), and sodium bisulfite (0.03 g) in water, reacting the mixture at a temperature of 65° C. for 6 h in a vacuum to obtain an aqueous positive electrode binder.

### Preparation Example 2

Synthesis of Binder 2: dissolving N-vinylimidazole (5.64 g, 60 mmol), butyl acrylate (3.84 g, 30 mmol), N-hydroxyethyl acrylamide (1.15 g, 10 mmol), ammonium persulfate (0.1 g), and sodium bisulfite (0.03 g) in water, reacting the mixture at a temperature of 65° C. for 6 h in a vacuum to obtain an aqueous positive electrode binder.

### Preparation Example 3

Synthesis of Binder 3: dissolving acrylamide (4.27 g, 60 mmol), ethyl acrylate (3.0 g, 30 mmol), N-hydroxyethyl acrylamide (1.15 g, 10 mmol), ammonium persulfate (0.1 g), and sodium bisulfite (0.03 g) in water, reacting the mixture at a temperature of 65° C. for 6 h in a vacuum to obtain an aqueous positive electrode binder.

### Preparation Example 4: Preparation of the Lithium Ion Battery

(1) Preparation of a Positive Electrode Plate

Mixing a positive active material lithium cobaltate (LCO), a binder and a conductive agent acetylene black in a mass ratio of 97:1.5:1.5, adding the mixture into a solvent (where, PVDF uses N-methylpyrrolidone (NMP) as the solvent, and the other binders use water as the solvent), stirring under a vacuum mixer until the mixture system forming a positive electrode slurry with uniform fluidity; evenly applying the positive electrode slurry to a current collector aluminum foil (the thickness of the aluminum foil was 10 μm); baking the applied aluminum foil through an oven, and then drying it in an oven at a temperature of 120° C. for 8 h, followed by rolling and cutting it to obtain the required positive electrode plate.

Peeling Force Test of the Positive Electrode Plate:

the preparation of samples: firstly cutting the rolled positive electrode plate into strips with the length of 170 mm and the width of 30 mm using a flat paper cutter; then wiping a scale-free steel ruler cleanly using degreased gauze, without leaving stains or dust; then horizontally pasting a 60 mm width transparent adhesive tape to the bottom of the air-dried scale-free steel ruler, with the end face of the transparent adhesive tape flush with the end face of the scale-free steel ruler; and then, pasting a 25 mm width double-sided adhesive tap to the transparent adhesive tape, with the same length as the width of the transparent adhesive tape, and the center position; and finally, bonding the test samples on the double-sided adhesive tap with the end face of the test samples flush with the end face of the double-sided adhesive tap, and rolling on the surface of the positive electrode plate up and down using a pressing wheel (2 kg) with a diameter of 84 mm and a height of 45 mm.

Test of peeling force: folding the free end of the positive electrode plate of the test samples by 180°; then clamping the above folded positive electrode plate on the upper clamp holder of the AG-X plus electronic universal material testing machine; clamping the scale-free steel ruler on the lower clamp holder; preparing a plurality of positive electrode plates with the width of 30 mm at a temperature ranging from 22° C. to 28° C. and a humidity less than 25%, making the stretching speed of the electrode plate 50 mm/min, and testing the average value at the stretching of 25 mm to 80 mm; peeling the positive electrode plate, and reading the test result of the peeling strength of the coating when the current collector and the coating were completely separated. The calculation method of the peeling strength is: Peeling Strength=Peeling Force÷Electrode Plate Width.

(2) Preparation of a Negative Electrode Plate

Mixing a negative active material graphite, a thickener sodium carboxymethylcellulose (CMC-Na), a binder (ZEON 451B), and a conductive agent acetylene black in a mass ratio of 96%:1.2%:1.8%:1%, and adding the mixture into deionized water, stirring under a vacuum mixer to obtain a negative electrode slurry; evenly applying the negative electrode slurry to a high-strength copper foil coated with carbon (the thickness of the copper foil was 6 μm) to obtain a electrode plate; and airing the obtained electrode plate at room temperature, then transferring the electrode plate into an oven at a temperature of 80° C. and drying for 10 h, followed by rolling and cutting to obtain the negative electrode plate.

(3) Preparation of Electrolyte

In a glove box filled with inert gas (argon) (H₂O<0.1 ppm, O₂<0.1 ppm), mixing EC (ethylene carbonate), EMC (methyl ethyl carbonate), DEC (diethyl carbonate); FEC (fluorinated ethylene carbonate) in a mass ratio of 20:50:20:10 to prepare a solution, then adding fully dried lithium hexafluorophosphate (LiPF₆) and lithium bis(fluorosulfonyl) imide (LiFSI) into the solution rapidly, where the mass fraction of the LiPF₆ and the LiFSI in the system was 11.4% and 3.1% respectively; dissolving in a non-aqueous organic solvent, and evenly stirring. After the test results of the moisture and the residual acid were passed, the electrolyte was obtained.

(4) Preparation of a Separator

Selecting a separator coated by (5+3) ZhuoGao mixture layer with a thickness of 8 μm.

(5) Preparation of a Lithium Ion Battery

Stacking the prepared positive electrode plate, separator, and negative electrode plate in sequence to ensure the separator was located between the positive electrode plate and the negative electrode plate and plays a role in isolation, then winding to obtain a bare cell without electrolyte, placing the bare cell in an outer packaging foil, injecting the prepared corresponding electrolyte into the dried bare cell, followed by vacuum packaging, standing, chemical conversion, shaping, sorting and other processes to obtain a lithium ion battery.

### Comparative Example 1

A commercial oil-based PVDF (model: ARKEMA HSV 900) was used as the binder, and the cell was prepared as described in Preparation Example 4.

### Comparative Example 2

A commercial aqueous binder (model: INDIGO 136 D) was used as the binder, and the cell was prepared as described in Preparation Example 4.

### Comparative Example 3

A commercial polyvinyl pyrrolidone (Mw: 40000, purchased from Sigma-aldrich) was used as the binder, and the cell was prepared as described in Preparation Example 4.

### Comparative Example 4

A commercial polyvinyl imidazole (Mw: 400000, purchased from Innochem) was used as the binder, and the cell was prepared as described in Preparation Example 4.

### Comparative Example 5

A commercial polyacrylamide (Mw: 600000, purchased from Innochem) was used as the binder, and the cell was prepared as described in Preparation Example 4.

### Example 1

The Binder 1 was used as the binder, and the cell was prepared as described in Preparation Example 4.

### Example 2

The Binder 2 was used as the binder, and the cell was prepared as described in Preparation Example 4.

### Example 3

The Binder 3 was used as the binder, and the cell was prepared as described in Preparation Example 4.

Mechanical Performance Test of the Binder:

Preparing the binders in the Comparative Examples and Examples into strip samples having size of length×width×height was 32 mm×12 mm×1 mm, respectively, stretching on a universal stretching testing machine with a stretching rate of 50 mm/min under a condition of 22° C. to 28° C. and a humidity of 30%, and the specific data is shown in Table 1.

TABLE 1
Mechanical performance data of the binders in Comparative
Examples 1 to 5 and Examples 1 to 3.

| | Maximum | |
|---|---|---|
| | stretching | Elongation |
| | strength (GPa) | at break(%) |
| The binder of Comparative Example 1 | 0.6 | 20 |
| The binder of Comparative Example 2 | 1.1 | 4 |
| The binder of Comparative Example 3 | 1.9 | 3 |
| The binder of Comparative Example 4 | 0.9 | 5 |
| The binder of Comparative Example 5 | 3.2 | 3 |
| The binder of Example 1 | 0.8 | 30 |
| The binder of Example 2 | 0.9 | 26 |
| The binder of Example 3 | 1.0 | 29 |

It can be seen from Table 1 that the maximum stretching strength of the binder PVDF in Comparative Example 1 is lower than that of Comparative Examples 2 to 5, but the elongation at break is much higher than that of Comparative Examples 2 to 5, indicating that the PVDF has better flexibility, so that the electrode plate is not easy to crack in the drying process, and the risk of dropping powder in the winding process is reduced.

However, the maximum stretching strength of the binder in Examples 1-3 is higher than that of Comparative Example 1, which is mainly due to the reason that the self cross-linking group is introduced in the synthesis process to form the cross-linked network, thereby improving the cohesion of the binder and further improving the maximum stretching strength. In addition, the elongation at break of the binders in Examples 1 to 3 are also superior to that of Comparative Example 1, which is mainly due to the introduction of part of the flexible groups into the binders, thereby improving the flexibility of the binders, and the elongation at break is superior to that of the traditional PVDF binder.

Performance Test of the Lithium Ion Battery
(1) 45° C. Cycle Test: charging the battery to 4.45 V at 1 C at a constant temperature of 45° C., with a 0.05 C cut-off current, then discharging it to 3 V at 0.5 C. The process of charging and discharging was cycled for 500 times. The cyclic discharge capacity was recorded and divided by the discharge capacity of the first cycle to obtain a normal-temperature cycle capacity retention rate. Recording cycle capacity retention rates of the 100/300/500 times and post-cycling thickness swelling rates when the batteries cycle for 100/300/500 times, respectively. The results are recorded in Table 2.

TABLE 1
Cyclic performance test results of the lithium ion batteries
in Comparative Examples 1 to 5 and Examples 1 to 3.

| | Average | | | | |
|---|---|---|---|---|---|
| | peeling | | | | |
| | strength of | | Capacity | Capacity | Capacity |
| | the positive | Starting | retention | retention | retention |
| | electrode | capacity | rate after | rate after | rate after |
| Group | plate (N/m) | (mAh) | 100 cycles | 300 cycles | 500 cycles |
| Comparative | 9.2 | 3010 | 96.2% | 91.3% | 87.4% |
| Example 1 | | | | | |
| Comparative | 10.6 | 3012 | 95.1% | 90.3% | 85.6% |
| Example 2 | | | | | |
| Comparative | 9.1 | 3014 | 94.7% | 89.4% | 84.3% |
| Example 3 | | | | | |
| Comparative | 8.1 | 2986 | 91.6% | 82.5% | 74.6% |
| Example 4 | | | | | |
| Comparative | 8.2 | 2993 | 90.7% | 81.5% | 73.1% |
| Example 5 | | | | | |
| Example 1 | 11.7 | 3016 | 97.4% | 92.6% | 88.7% |
| Example 2 | 10.4 | 3011 | 96.5% | 91.6% | 88.2% |
| Example 3 | 9.9 | 3013 | 96.3% | 91.2% | 87.3% |

The Comparative Examples 1 to 5 use the commercial oil-based PVDF, the aqueous 136D, the polyvinyl pyrrolidone, the polyvinyl imidazole, and the polyacrylamide as the positive electrode binder respectively. From the data of the stretching strength of the rolled positive electrode plate, it can be seen that the average peeling strength of the aqueous 136D is greater than that of the conventional oil-based binder PVDF, while the average peeling strength of the polyvinyl pyrrolidone, the polyvinyl imidazole and the polyacrylamide are less than that of PVDF.

However, the peeling strength of the binders in Examples 1 to 3 are superior to that of PVDF, which is mainly due to the distribution of the binder is more uniform caused by the dispersion monomer, and the flexibility and motion capability of the binder is improved by the flexibility monomer, so that the interaction between the main materials is improved. The self cross-linking monomer constructs the cross-linked network, leading to improving the interaction between the binders, and achieving the improvement of the peeling strength.

In addition, in terms of the cell capacity retention ratio, the PVDF binder of Comparative Example 1 is superior to those of Comparative Examples 2 to 5, which is related to the good dispersibility to the positive active material and its own good flexibility, while the capacity retention rates in Examples 1 to 3 are superior than that of Comparative Example 1, especially in Example 1, the capacity retention rate performance is optimal.
(2) Rate Charging Performance Test: the specific testing process is as follows: testing the state voltage, the internal resistance and the thickness of the samples at an environment of (25±5)° C., determining whether the cell is normal, and then testing according to the following steps: 1, standing at an environment of (25±2)° C. for 10 min; 2, discharging to a lower limit voltage at 0.2 C; 3, standing for 10 min; 4, charging at a certain rate (charging rate: 0.2 C/0.5 C/1 C/1.5 C/2 C/3 C), the cut-off current is 0.025 C; 5, standing for 10 min; 6, discharging to the lower limit voltage at 0.2 C; 7, standing for 10 min, and repeating the steps 4 to 7 until all the charging rate tests are completed. The test data is recorded in Table 3.

TABLE 3
Rate charging performance of the lithium ion batteries
of Comparative Examples and Examples

| | Charging | | | | Comparative |
|---|---|---|---|---|---|
| | rate | Example 1 | Example 2 | Example 3 | Example 1 |
| constant- | 0.2 C | 92.41% | 91.57% | 91.56% | 91.07% |
| current | 0.5 C | 83.89% | 83.00% | 82.88% | 82.09% |
| charging | 1.0 C | 74.69% | 73.58% | 73.30% | 72.28% |
| ratio | 1.5 C | 66.87% | 65.74% | 65.12% | 64.04% |
| | 2.0 C | 59.25% | 57.90% | 57.18% | 55.47% |
| | 3.0 C | 43.58% | 42.35% | 41.08% | 38.86% |

It can be seen from Table 3 that the constant-current charging ratio at different charging rate in Examples 1 to 3 using the aqueous binders are superior to that of Comparative Example 1 using the traditional oil-based PVDF binder, indicating that the aqueous binder has better rate charging performance.

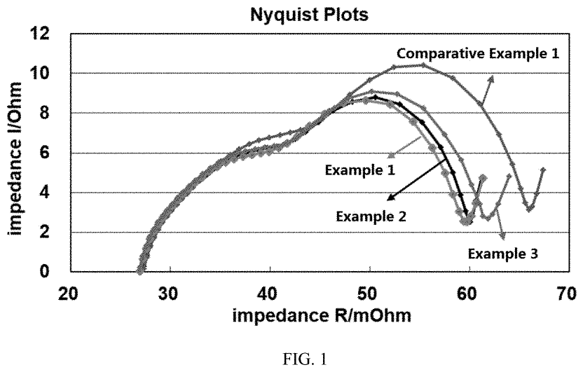

Electrochemical Impedance Test: letting the battery stand at a constant environment at 45° C., and constant charging to 4.45 V at 1 C with a 0.05 C cut-off current. Performing EIS Test with the fully charged batteries. The specific data is shown in Table 4 and FIG. 1.

TABLE 4
Electrochemical impedance data of the batteries
in Examples 1 to 3 and Comparative Example 1

| | | | | Comparative |
|---|---|---|---|---|
| EIS Test | Example 1 | Example 2 | Example 3 | Example 1 |
| Rₛ/mΩ | 24.70 | 25.10 | 24.60 | 25.00 |
| R_{SEI}/mΩ | 23.00 | 23.30 | 24.80 | 27.70 |
| R_{ct}/mΩ | 11.20 | 11.00 | 11.60 | 13.00 |
| [symbol] /mΩ | 58.90 | 59.40 | 61.00 | 65.70 |

It can be seen from Table 4 and FIG. 1 that the body resistance Rₛ, the transmission impedance of SEI film R_{SEI}, and the interface transmission impedance R_{ct} and the like in Examples 1 to 3 using the aqueous binders are superior to that in Comparative Example 1 using the oil-based binder PVDF, and further indicating that the aqueous binder has better dynamical performance.

In summary, it can be seen that the aqueous positive electrode binder provided by the present disclosure has self cross-linking performance, strong bonding performance and good flexibility. The binder is applied to the positive active materials such as lithium iron phosphate and lithium cobaltate, resulting that the processability is good, the solid content of the slurry is high, the peeling force of the applied electrode plate is high, the cyclic stability is good, the rate performance is superior to that of the PVDF binder, the binder is green and environment-friendly, and it is expected to replace the PVDF in the batteries and achieve large-scale application.

The implementations of the present disclosure have been illustrated above. However, the present disclosure is not limited to the above-mentioned implementations. Any modification, equivalent replacement, improvement, or the like, made within the spirit and principles of the present disclosure shall fall within the protection scope of the present disclosure.

What is claimed is:

1. A binder, comprising at least one polymer, and the polymer comprising at least one repeating unit shown in Formula 1, at least one repeating unit shown in Formula 2, and at least one repeating unit shown in Formula 3: 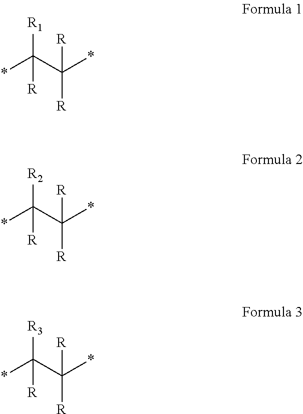
wherein, R₁ is a dispersion group, R₂ is a flexible group, and R₃ is a self cross-linkable group; Rs are the same or different, and are independently selected from C₁₋₆ alkyl or hydrogen; * is a connecting end.

2. The binder according to claim 1, wherein R₁ is selected from 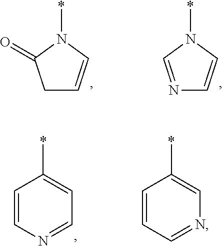 [SMILES: *N1C=CCC1=O ; *n1ccnc1 ; *c1ccncc1 ; *c1cccnc1]
CONHR′, —CN, —COOH, —COOLi, or —COONa, and R′ is H or C₁₋₆ alkyl;
and/or, R₁ is derived from a polymerizable monomer comprising a carbon-carbon double bond and having dispersion performance, which is selected from at least one of: 1-vinyl-2-pyrrolidone, 1-vinylimidazole, vinylpyridine, methacrylamide, methacrylonitrile, methacrylic acid, lithium methacrylate, sodium methacrylate, acrylamide, vinyl cyanide, propenoic acid, lithium acrylate, or sodium acrylate.

3. The binder according to claim 1, wherein R₂ is selected from —COOR₄, —COO—(CH₂CH₂I)ₙ—CH₃, or —COOR₅—OH; and R₄ is C₁₋₆ alkyl, R₅ is C₁₋₆ alkylene, and n is an integer from 1 to 15;
and/or, R₂ is derived from a flexible polymerizable monomer comprising a carbon-carbon double bond, which is selected from at least one of: methyl acrylate, ethyl acrylate, propyl acrylate, butyl acrylate, pentyl acrylate, hydroxyethyl acrylate, poly(ethylene glycol) methyl ether methacrylate.

4. The binder according to claim 1, wherein R₃ is selected from —C(OH)═N—R₆—OH, 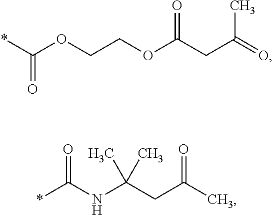 [SMILES: *C(=O)OCCOC(=O)CC(C)=O ; *C(=O)NC(C)(C)CC(C)=O]
and R₆ is C₁₋₆ alkylene;
and/or, R₃ is derived from a polymerizable monomer comprising a carbon-carbon double bond and having self cross-linking performance, which is selected from at least one of: acetoacetoxyethyl methacrylate, N-hydroxymethyl acrylamide, N-hydroxyethyl acrylamide or diacetone acrylamide.

5. The binder according to claim 1, wherein the repeating unit shown in Formula 1 accounts for 40 mol % to 80 mol % of the total mole of the polymer.

6. The binder according to claim 1, wherein the repeating unit shown in Formula 2 accounts for 20 mol % to 50 mol % of the total mole of the polymer.

7. The binder according to claim 1, wherein the repeating unit shown in Formula 3 accounts for 0.1 mol % to 10 mol % of the total mole of the polymer.

8. The binder according to claim 1, wherein a weight-average molecular weight of the polymer is 3000 Da to 2 million Da.

9. The binder according to claim 1, wherein a decomposition temperature of the polymer is greater than 300° C.

10. The binder according to claim 1, wherein a maximum stress of the polymer is 0.1 MPa to 1000 MPa.

11. The binder according to claim 1, wherein an elongation at break of the polymer is 5% to 600%.

12. The binder according to claim 1, wherein the polymer have a structural formula as shown in the following formula I: 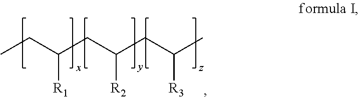
and x:y:z is (40 mol %-80 mol %):(20 mol %-50 mol %):(0.1 mol %-10 mol %).

13. The binder according to claim 12, wherein the polymer have a structural formula as shown in the following formula II:

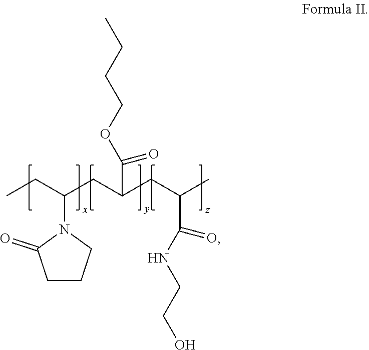

14. The binder according to claim 1, wherein the binder further comprises a solvent component, and the solvent component is water.

15. The binder according to claim 1, wherein the solid content of the binder ranges from 0.1 wt % to 10 wt %.

16. The binder according to claim 1, wherein the viscosity of the binder ranges from 100 mPa·s to 30000 mPa·s.

17. The binder according to claim 1, wherein the pH value of the binder ranges from 5 to 7.

18. A positive electrode plate, comprising the binder according to claim 1.

19. The positive electrode plate according to claim 18, wherein the positive electrode plate comprises a positive current collector and a positive active material layer applied to at least one side of a surface of the positive current collector, and the positive active material layer comprises the binder; and/or,
an addition amount of the binder accounts for 0.2 wt % to 25 wt % of the total mass of the positive active material layer; and/or,
an average peeling strength of the positive electrode plate comprising the binder is 0.1 N/m to 30 N/m.

20. A battery, comprising the binder according to claim 1.
